(19) United States
(12) Patent Application Publication
(10) Pub. No.: US 2026/0179835 A1
(43) Pub. Date: Jun. 25, 2026

(54) MULTILAYER ELECTRONIC COMPONENT

(71) Applicant: SAMSUNG ELECTRO-MECHANICS CO., LTD., Suwon-si (KR)

(72) Inventors: Kyung Ho LEE, Suwon-si (KR); Hae Suk CHUNG, Suwon-si (KR); Young Ghyu AHN, Suwon-si (KR); Joon Yeob CHO, Suwon-si (KR)

(73) Assignee: SAMSUNG ELECTRO-MECHANICS CO., LTD., Suwon-si (KR)

(21) Appl. No.: 19/372,210

(22) Filed: Oct. 28, 2025

(30) Foreign Application Priority Data
Dec. 20, 2024 (KR) 10-2024-0192239

(51) Int. Cl. H01G 4/008; H01G 4/12; H01G 4/30

(52) U.S. Cl. CPC H01G 4/008; H01G 4/30; H01G 4/1227

(57) ABSTRACT

A multilayer electronic component includes a body including a dielectric layer and an internal electrode alternately disposed with the dielectric layer, and an external electrode disposed on the body. The internal electrode includes a plurality of electrode portions and a plurality of disconnected portions, and conductive glass is disposed in at least one of the plurality of disconnected portions.

### CROSS-REFERENCE TO RELATED APPLICATION(S)

This application claims benefit of priority to Korean Patent Application No. 10-2024-0192239 filed on Dec. 20, 2024 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-type condenser mounted on the printed circuit boards of various types of electronic products such as imaging devices, including a liquid crystal display (LCD) and a plasma display panel (PDP), computers, smartphones, and mobile phones, and serves to charge or discharge electricity therein or therefrom.

The MLCC may be used as a component of various electronic devices due to having a small size, ensuring high capacitance and being easily mounted.

In a manufacturing process of an MLCC, an internal electrode may be sintered before a dielectric layer is sintered. In this case, the internal electrode may shrink, such that pores may occur in a space previously occupied by the electrode. Due to the occurrence of pores, an area of the internal electrode may be reduced, which may lead to a decrease in capacitance of an MLCC. In addition, stress may be concentrated in a portion to which a remaining electrode is connected, and cracks may occur or propagate, which may cause disconnection of the internal electrode. Such disconnection of the internal electrode may become more severe as a thickness of the internal electrode is reduced, and may serve as a main cause of degradation in characteristics of the MLCC.

Accordingly, there is a need for a method of compensating for a disconnected portion of an internal electrode to improve reliability of a multilayer electronic component and to suppress a decrease in capacitance of the multilayer electronic component.

### DOCUMENT

### Patent Document

(Patent Document 1) Korean Patent Application Publication No. 10-2019-0116144

### SUMMARY

An aspect of the present disclosure is to provide a multilayer electronic component having excellent reliability.

Another aspect of the present disclosure is to provide a multilayer electronic component having excellent capacitance per unit volume.

Another aspect of the present disclosure is to provide a multilayer electronic component in which the occurrence and propagation of cracks are suppressed.

However, the aspects of the present disclosure are not limited to those set forth herein, and will be more easily understood in the course of describing specific example embodiments of the present disclosure.

According to an aspect of the present disclosure, there is provided a multilayer electronic component including a body including a dielectric layer and an internal electrode alternately disposed with the dielectric layer, and an external electrode disposed on the body. The internal electrode may include a plurality of electrode portions and a plurality of disconnected portions, and conductive glass may be disposed in at least one of the plurality of disconnected portions.

According to example embodiments of the present disclosure, conductive glass may be disposed in a disconnected portion of an internal electrode, thereby suppressing a decrease in capacitance caused by the disconnected portion.

However, the various advantages and effects of the present disclosure are not limited to those set forth herein, and will be more easily understood in the course of describing specific example embodiments of the present disclosure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a multilayer electronic component according to an example embodiment of the present disclosure;

FIG. 2 is a schematic cross-sectional view taken along line I-I′ of FIG. 1;

FIG. 3 is a schematic cross-sectional view taken along line II-II′ of FIG. 1;

FIG. 4 is a schematic exploded view of a body;

FIG. 5 is a schematic partially enlarged view of a body before sintering;

FIG. 6 schematically illustrates a state after sintering of FIG. 5;

FIG. 7 is a schematic enlarged view of an internal electrode; and

FIG. 8 schematically illustrates conductive glass.

### DETAILED DESCRIPTION

Hereinafter, example embodiments of the present disclosure are described with reference to the accompanying drawings. The present disclosure may, however, be exemplified in many different forms and should not be construed as being limited to the specific example embodiments set forth herein. In addition, example embodiments of the present disclosure may be provided for a more complete description of the present disclosure to those skilled in the art. Accordingly, the shapes and sizes of the elements in the drawings may be exaggerated for clarity of description, and elements denoted by the same reference numerals in the drawings may be the same elements.

In order to clearly illustrate the present disclosure, portions not related to the description are omitted, and sizes and lengths are magnified in order to clearly represent layers and regions, and similar portions having the same functions within the same scope are denoted by similar reference numerals throughout the specification. Throughout the specification, when an element is referred to as “comprising” or “including,” it means that it may include other elements as well, rather than excluding other elements, unless specifically stated otherwise.

In the drawings, an X-direction may be defined as a first direction, a lamination direction, or a thickness (T) direction, a Y-direction may be defined as a second direction or a length (L) direction, and a Z-direction may be defined as a third direction or a width (W) direction.

### MULTILAYER ELECTRONIC COMPONENT

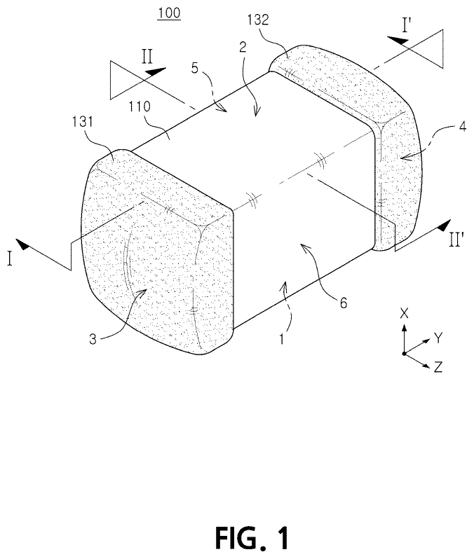

FIG. 1 schematic perspective view of a multilayer electronic component according to an example embodiment of the present disclosure.

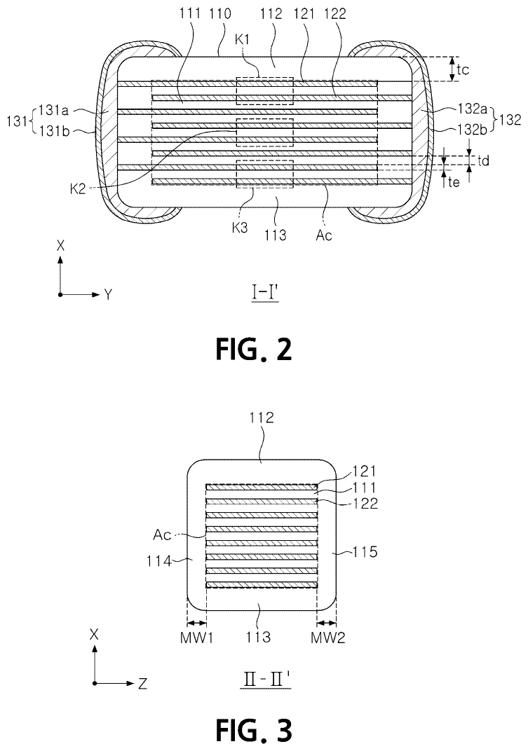

FIG. 2 is a schematic cross-sectional view taken along line I-I′ of FIG. 1.

FIG. 3 is a schematic cross-sectional view taken along line II-II′ of FIG. 1.

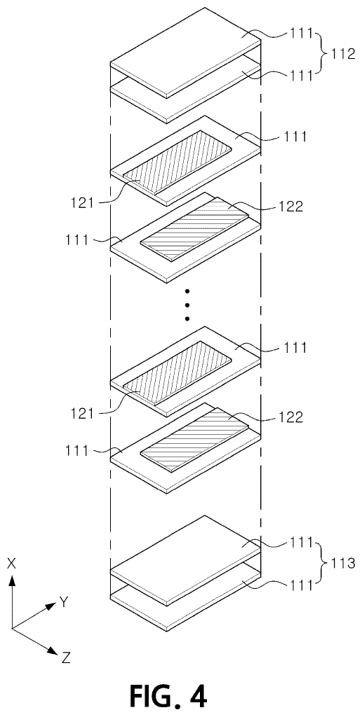

FIG. 4 is a schematic exploded view of a body.

Hereinafter, a multilayer electronic component 100 according to an example embodiment of the present disclosure will be described in detail with reference to FIGS. 1 to 4. In addition, a multilayer ceramic capacitor (hereinafter referred to as “MLCC”) is described as an example of the multilayer electronic component, but the present disclosure is not limited thereto, and may be applied to various electronic products formed of a ceramic material, such as inductors, piezoelectric elements, varistors, thermistors, or the like.

According to an example embodiment of the present disclosure, a multilayer electronic component 100 may include a body 110 including a dielectric layer 111 and internal electrodes 121 and 122 alternately disposed with the dielectric layer 111, and external electrodes 131 and 132 disposed on the body. The internal electrode may include a plurality of electrode portions Ep and a plurality of disconnected portions Cp, and conductive glass may be disposed on at least one of the plurality of disconnected portions Cp.

During a sintering process, disconnection of the internal electrode may occur due to a difference in sintering shrinkage behavior between the internal electrode and the dielectric layer, such that each of the internal electrodes 121 and 122 may include a disconnected portion Cp in addition to an electrode portion Ep. In general, the disconnected portion Cp of the internal electrode may be formed as a pore Pp. The pore Pp may reduce capacitance of the multilayer electronic component, may serve as microcracks within the body to cause occurrence and propagation of cracks, and may allow moisture to easily permeate a pore portion. As a result, the internal electrode may become vulnerable to oxidation.

In the related art, there have been attempts to reduce the pores Pp and to improve bonding force with the dielectric layer by filling the disconnected portion Cp with a dielectric, thereby suppressing delamination and cracks.

However, even when the disconnected portion Cp is filled with a dielectric, it may be difficult to resolve an issue such as a decrease in capacitance caused by the disconnected portion Cp.

Conversely, according to the present disclosure, the disconnected portion Cp may be filled with conductive glass Cg to reduce the pores Pp and increase bonding force with the dielectric layer 111, thereby not only suppressing delamination and cracks, but also preventing a decrease in capacitance caused by the disconnected portion Cp.

In addition, in order to suppress the disconnected portion Cp, when a material and/or a sintering condition of the internal electrode are significantly changed, the dielectric layer may not be sintered. However, according to an example embodiment of the present disclosure, the disconnected portion Cp may be compensated for without significantly changing the sintering condition.

Hereinafter, each of components included in the multilayer electronic component 100 according to an example embodiment of the present disclosure will be described.

In the body 110, the dielectric layer 111 and the internal electrodes 121 and 122 may be alternately laminated.

A specific shape of the body 110 is not limited. However, as illustrated, the body 110 may have a hexahedral shape or a shape similar thereto. During a sintering process, ceramic powder particles, included in the body 110, may shrink, such that the body 110 may not have a hexahedral shape having perfectly straight lines, but may have a substantially hexahedral shape.

The body 110 may have first and second surfaces 1 and 2 opposing each other in a first direction, third and fourth surfaces 3 and 4 connected to the first and second surfaces 1 and 2, the third and fourth surfaces 3 and 4 opposing each other in a second direction, and fifth and sixth surfaces 5 and 6 connected to the third and fourth surfaces 3 and 4, the fifth and sixth surfaces 5 and 6 opposing each other in a third direction.

As margin regions in which the internal electrodes 121 and 122 are not disposed on the dielectric layer 111 overlap each other, a step portion may be formed due to thicknesses of the internal electrodes 121 and 122, such that an corner, connecting the first surface and the third to fifth surfaces to each other, and/or an corner, connecting the second surface and the third to fifth surfaces to each other, may shrink toward a center in the first direction of the body 110, with respect to the first surface or the second surface. Alternatively, due to shrinkage behavior of the body during a sintering process, an corner, connecting the first surface 1 and the third to sixth surfaces 3, 4, 5, and 6 to each other, and/or an corner, connecting the second surface 2 and the third to sixth surfaces 3, 4, 5, and 6 to each other, may shrink toward the center in the first direction of the body 110, with respect to the first surface or the second surface. Alternatively, in order to prevent chipping defects, an additional process may be performed to round corners connecting respective surfaces of the body 110 to each other. Accordingly, the corner, connecting the first surface and the third to sixth surfaces to each other, and/or the corner, connecting the second surface and the third to sixth surfaces to each other, may have a round shape.

In order to suppress a step portion caused by the internal electrodes 121 and 122, internal electrodes may be laminated and then cut to be exposed to the fifth and sixth surfaces 5 and 6 of the body. Thereafter, one dielectric layer or two or more dielectric layers may be laminated on both side surfaces of a capacitance formation portion Ac in a third direction (width direction) to form margin portions 114 and 115. In this case, a portion, connecting a first surface and fifth and sixth surfaces to each other, and a portion, connecting a second surface and the fifth and sixth surfaces to each other, may not shrink.

A plurality of dielectric layers 111, included in the body 110, may be in a sintered state, and adjacent dielectric layers 111 may be integrated with each other such that boundaries therebetween are not readily apparent without using a scanning electron microscope (SEM). The number of laminated dielectric layers is not limited, and may be determined in consideration of a size of the multilayer electronic component. For example, the body may be formed by laminating 400 or more dielectric layers.

The dielectric layer 111 may be formed by preparing a ceramic slurry including ceramic powder particles, an organic solvent, and a binder, coating the slurry on a carrier film and drying the same to prepare a ceramic green sheet, and then sintering the ceramic green sheet. The ceramic powder particles are not limited as long as sufficient capacitance is obtainable therewith, and may be, for example, barium titanate-based (BaTiO₃)-based powder particles and CaZro₃-based paraelectric powder particles. As a more specific example, the barium titanate-based (BaTiO₃)-based powder particles may be at least one of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), and Ba(Ti_{1-y}Zr_{y})O₃ (0<y<1), and CaZrO₃-based paraelectric powder particles may be (Ca₁₋ₓSrₓ)(Zr_{1-y}Ti_{y})O₃ (0<x<1, 0<y<1).

Accordingly, the dielectric layer 111 may include at least one of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), and (Ca₁₋ₓSrₓ)(Zr_{1-y}Ti_{y})O₃ (0<x<1, 0<y<1).

An average thickness (td) of the dielectric layer 111 is not limited, but may be, for example, 10 μm or less. In addition, the average thickness (td) of the dielectric layer 111 may be arbitrarily set depending on desired characteristics or usage.

The average thickness (td) of the dielectric layer 111 may refer to a size in the first direction of the dielectric layer 111 disposed between the internal electrodes 121 and 122. The average thickness (td) of the dielectric layer 111 may be measured, for example, by scanning, with an SEM, a cross-section in the first and second directions of the body 110 at a magnification of 10,000. More specifically, the average thickness (td) of the dielectric layer 111 may be measured by measuring thicknesses of one dielectric layer 111 at multiple points of the dielectric layer 111, for example, thirty points spaced apart from each other at equal intervals in the second direction, and calculating an average value of the thicknesses. The thirty points, spaced apart from each other at equal intervals, may be designated in the capacitance formation portion Ac. In addition, when such average value measurement is performed on ten dielectric layers 111, the average thickness (td) of the dielectric layer 111 may be further generalized.

The body 110 may include a capacitance formation portion Ac disposed in the body 110, the capacitance formation portion Ac having capacitance by including the first internal electrode 121 and the second internal electrode 122 disposed to oppose each other with the dielectric layer 111 interposed therebetween, and cover portions 112 and 113 disposed on upper and lower portions in the first direction of the capacitance formation portion Ac.

In addition, the capacitance formation portion Ac may be a portion contributing to forming capacitance of a capacitor, and may be formed by repeatedly laminating a plurality of first and second internal electrodes 121 and 122 on each other with the dielectric layer 111 interposed therebetween.

The cover portions 112 and 113 may include an upper cover portion 112 disposed on the upper portion in the first direction of the capacitance formation portion Ac, and a lower cover portion 113 disposed on the lower portion in the first direction of the capacitance formation portion Ac.

The upper cover portion 112 and the lower cover portion 113 may be respectively formed by laminating one dielectric layer or two or more dielectric layers on upper and lower surfaces of the capacitance formation portion Ac in a thickness direction, and may basically serve to prevent the internal electrode from being damaged due to physical or chemical stress.

The upper cover portion 112 and the lower cover portion 113 may not include the internal electrode, and may include a material the same as that of the dielectric layer 111.

That is, the upper cover portion 112 and the lower cover portion 113 may include a ceramic material, and may include, for example, a barium titanate (BaTiO₃)-based ceramic material.

A thickness of each of the cover portions 112 and 113 is not limited. For example, a thickness (tc) of each of the cover portions 112 and 113 may be 200 μm or less.

An average thickness (tc) of each of the cover portions 112 and 113 may refer to a size in the first direction of each of the cover portions 112 and 113, and may have a value obtained by averaging sizes of each of the cover portions 112 and 113 in the first direction, measured at five points spaced apart from each other at equal intervals of an upper portion or lower portion of the capacitance formation portion Ac.

In addition, the margin portions 114 and 115 may be disposed on side surfaces of the capacitance formation portion Ac, respectively.

The margin portions 114 and 115 may include a first margin portion 114 disposed on the fifth surface 5 of the body 110 and a second margin portion 115 disposed on the sixth surface 6 of the body 110. That is, the margin portions 114 and 115 may be disposed on both end surfaces in a width direction of the ceramic body 110, respectively.

As illustrated in FIG. 3, the margin portions 114 and 115 may refer to regions between both ends of each of the first and second internal electrodes 121 and 122 and an interface of the body 110 in a cross-section of the body 110 cut in a width-thickness (W-T) direction.

The margin portions 114 and 115 may basically serve to prevent the internal electrode from being damaged due to physical or chemical stress.

The margin portions 114 and 115 may be formed by forming the internal electrode by coating a conductive paste on a ceramic green sheet, except for a portion of the ceramic green sheet on which a margin portion is to be formed.

In addition, in order to suppress a step portion caused by the internal electrodes 121 and 122, the internal electrodes may be laminated and then cut to be exposed to the fifth and sixth surfaces 5 and 6 of the body. Thereafter, one dielectric layer or two or more dielectric layers may be laminated on both side surfaces of the capacitance formation portion Ac in the third direction (width direction) to form the margin portions 114 and 115.

A width of each of the margin portions 114 and 115 is not limited. For example, an average width of each of the margin portions 114 and 115 may be 200 μm or less.

The average width of each of the margin portions 114 and 115 may be an average size in the third direction (MW1) of a region in which the internal electrode is spaced apart from the fifth surface or an average size in the third direction (MW2) of a region in which the internal electrode is spaced apart from the sixth surface, and may have an average value of sizes in the third direction of each of the margin portions 114 and 115, measured at five points spaced apart from each other at equal intervals of a side surface of the capacitance formation portion Ac.

Accordingly, in an example embodiment, each of the average sizes in the third direction (MW1 and MW2) of regions in which the internal electrodes 121 and 122 are spaced apart from the fifth and sixth surfaces may be 200 μm or less.

The internal electrodes 121 and 122 may include a plurality of electrode portions Ep and a plurality of disconnected portions Cp, and the conductive glass Cg may be disposed in at least one of the plurality of disconnected portions Cp.

In the related art, there have been attempts to reduce the pores Pp and to improve bonding force with the dielectric layer by filling the disconnected portion Cp with a dielectric, thereby suppressing delamination and cracks. However, even when the disconnected portion Cp are filled with a dielectric, it may be difficult to resolve an issue such as a decrease in capacitance caused by the disconnected portion Cp.

Conversely, according to an example embodiment of the present disclosure, the conductive glass Cg may be disposed in at least one of the plurality of disconnected portions Cp. Accordingly, the pores Pp may be reduced and bonding force with the dielectric layer 111 may be increased, thereby not only suppressing delamination and cracks, but also preventing a decrease in capacitance caused by the disconnected portion Cp.

The conductive glass Cg may have excellent flowability, such that the conductive glass Cg may be easily filled in the disconnected portion during sintering. In addition, the conductive glass Cg may have conductivity, thereby preventing a decrease in capacitance caused by the disconnected portion Cp.

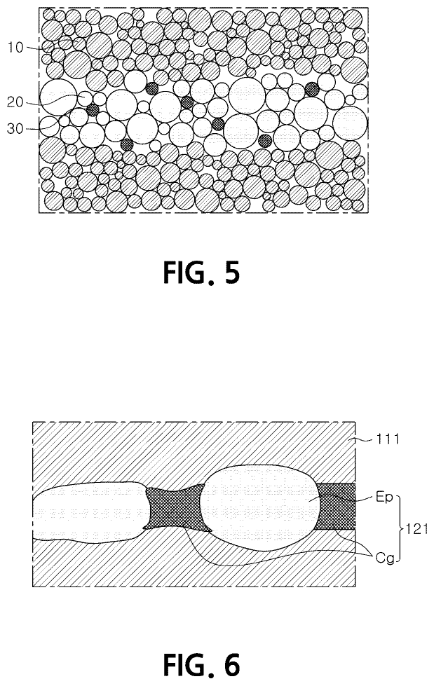

FIG. 5 is a schematic partially enlarged view of a body before sintering. FIG. 6 schematically illustrates a state after sintering of FIG. 5.

Referring to FIG. 5, an internal electrode paste including conductive metal powder particles 20 and conductive glass powder particles 30 may be positioned between ceramic green sheets including dielectric powder particles 10. As a sintering process is performed, the conductive metal powder particles 20 may begin to shrink earlier than the dielectric powder particles 10. Referring to FIG. 6, the conductive metal powder particles 20 may be sintered to form an electrode portion Ep, and the conductive glass powder particles 30 may be squeezed out to fill a disconnected portion, such that conductive glass may be disposed in the disconnected portion.

The conductive glass may refer to a material having both conductivity and transparency. In particular, the conductive glass having a Si—C bond may have higher thermal stability and easier manufacturability, as compared to other conductive glass. Si—C may be generally used as an anode material of a secondary battery, and the conductive glass having the Si—C bond is known to provide high cycle stability and high battery capacitance. When the conductive glass having the Si—C bond is mixed into the internal electrode paste, the conductive glass having the Si—C bond may be disposed in a disconnected portion of the internal electrode to reduce electric field concentration in the disconnected portion, thereby improving reliability.

Accordingly, in an example embodiment, the conductive glass Cg may include Si and C.

Referring to FIG. 8, the conductive glass powder particles 30 may include a core 31 and a shell 32 covering at least a portion of the core. The core 31 may include Si, and the shell 32 may include C. In FIG. 8, the shell 32, covering at least a portion of the core 31, is illustrated, but the shell 32 may also be disposed to entirely cover the core 31.

The conductive glass powder particles 30 may maintain the core-shell structure even after a sintering process, and may fill the disconnected portion Cp in the form of aggregated conductive glass powder particles 30.

Accordingly, in an example embodiment, the conductive glass Cg may include a core 31 and the shell 32 covering at least a portion of the core. The core 31 may include Si, and the shell 32 may include C.

In an example embodiment, at least one of the plurality of disconnected portions Cp may be formed of the conductive glass Cg. That is, as illustrated in FIG. 6, a disconnected portion between the electrode portions Ep may be entirely filled with the conductive glass Cg. However, all the disconnected portions may not need to be entirely filled with the conductive glass Cg, as illustrated in FIG. 6.

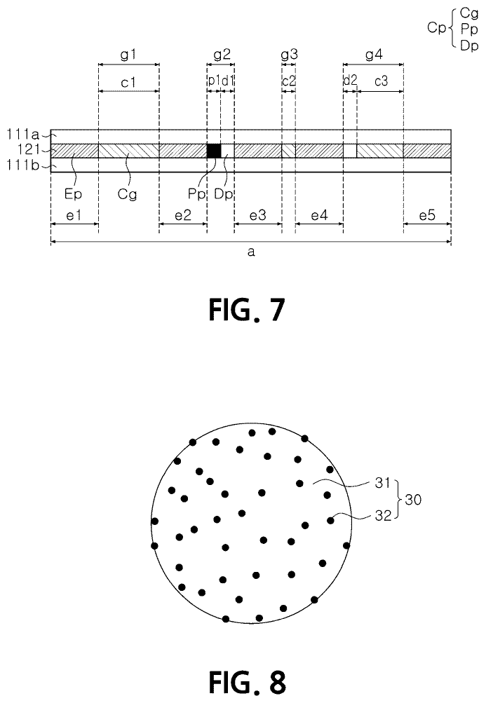

Referring to FIG. 7, in an example embodiment, the disconnected portion Cp may include at least one of the conductive glass Cg, a pore Pp, and a dielectric Dp.

The pore Pp, an empty space that is filled with air, may be a portion in which no bonding force is formed. The dielectric Dp may be disposed by diffusion of a portion of the dielectric layer 111.

In an example embodiment, the dielectric Dp may include a material the same as that of the dielectric layer 111. For example, the dielectric Dp may include BaTiO₃ as a main element. As used herein and unless otherwise indicated, “main element” means an element having the largest content among elements other than oxygen constituting the element.

A region of the internal electrode excluding the disconnected portion Cp may be referred to as an electrode portion Ep, and the electrode portion Ep may be formed by sintering the conductive metal powder particles 20.

In an example embodiment, the electrode portion Ep may include Ni as a main component.

In an example embodiment, the internal electrodes 121 and 122 may satisfy that a ratio of a length of the conductive glass to a length of the internal electrode is 0.1% to 15%. Accordingly, reliability may be improved and a decrease in capacitance may be suppressed. The length of the conductive glass may refer to a size in the second direction (Y direction) of the conductive glass, and the length of the internal electrode may refer to a size in the second direction (Y direction) of the internal electrode.

Referring to FIG. 7, the ratio of the length of the conductive glass to the length of the internal electrode may refer to a ratio of a length (c1+c2+c3) occupied by the conductive glass Cg to a total length of the internal electrode in an observed region, and may be calculated as (c1+c2+c3)/a*100(%).

More specifically, the ratio of the length of the conductive glass to the length of the internal electrode may be measured by polishing the body 110 up to a center in the third direction of the body to expose a cross-section in the first and second directions (hereinafter referred to as an “analysis cross-section”) of the body, and then scanning an image of the analysis cross-section with an SEM. Referring to FIG. 2, in the analysis cross-section, the capacitance formation region Ac may be divided in the first direction into three portions, that is, an upper portion, a central portion, and a lower portion. Predetermined regions K1, K2, and K3 may be set in each of the upper, central, and lower portions. An internal electrode included in the regions K1, K2, and K3 may be analyzed using SEM-EDS. A ratio of a total length of the conductive glass to a total length of the internal electrode may be calculated and used as the length ratio of the conductive glass to the internal electrode length. Each of the regions K1, K2, and K3 may be set to include ten layers of internal electrodes.

In an example embodiment, the internal electrodes 121 and 122 may have an internal electrode connectivity of 75% to 95%, which is the ratio of the length of the electrode portion Ep to the length of the internal electrode. According to an example embodiment of the present disclosure, even when the internal electrode connectivity is relatively low, a decrease in capacitance may be suppressed by disposing the conductive glass Cg in the disconnected portion Cp.

Referring to FIG. 7, the internal electrode connectivity may refer to a ratio of a sum (e1+e2+e3+e4+e5) of lengths of the electrode portion Ep to a total length (a) of the internal electrode 121, and may be calculated as (e1+e2+e3+e4+e5)/a*100(%).

In an example embodiment, a length ratio occupied by the conductive glass Cg in the disconnected portion Cp may be 50% or more. Accordingly, reliability may be further improved and a decrease in capacitance caused by the disconnected portion may be further suppressed. More preferably, the length ratio occupied by the conductive glass Cg in the disconnected portion Cp may be 70% or more.

Referring to FIG. 7, a total length of the disconnected portion Cp may be a sum of g1, g2, g3, and g4, and a total length of the conductive glass Cg may be a sum of c1, c2, and c3. Accordingly, the length ratio occupied by the conductive glass Cg in the disconnected portion Cp may be calculated as (c1+c2+c3)/(g1+g2+g3+g4)*100(%).

A length ratio occupied by the pore Pp in the disconnected portion Cp may be 20% or less, and a length ratio occupied by the dielectric Dp in the disconnected portion Cp may be 30% or less.

Referring to FIG. 7, a total length of the disconnected portion Cp may be a sum of g1, g2, g3, and g4, and a total length of the pore Pp may be pl. Accordingly, the length ratio occupied by the pore Pp in the disconnected portion Cp may be calculated as pl/(g1+g2+g3+g4)*100(%).

In addition, the length ratio occupied by the dielectric Dp in the disconnected portion Cp may be calculated as (d1+d2)/(g1+g2+g3+g4)*100(%).

A method of disposing the conductive glass Cg in the disconnected portion Cp is not limited. For example, when the conductive glass Cg is added to an internal electrode conductive paste and sintering is performed thereon, the internal electrodes 121 and 122 may be sintered, resulting in disconnection of the internal electrode. Subsequently, when grain growth of a dielectric grain of the dielectric layer 111 occurs, the conductive glass Cg remaining in the internal electrodes 121 and 122 may be squeezed out, and the disconnected portion Cp may be filled with the conductive glass Cg.

In an example embodiment, the internal electrodes 121 and 122 may include ceramic particles, and the ceramic particles may be disposed in the electrode portion Ep. The ceramic particles may be added to the internal electrode conductive paste. During a sintering process, the ceramic particles may be trapped in the electrode portion Ep. Even after the sintering process, the ceramic particles may disposed in the electrode portion Ep.

In an example embodiment, the dielectric layer 111 and the internal electrodes 121 and 122 may be alternately disposed in the first direction, and the disconnected portion Cp may be disposed to pass through the internal electrode in the first direction.

When the disconnected portion Cp is disposed to pass through the internal electrodes 121 and 122 in the first direction, cracks may be more likely to occur. Accordingly, when the disconnected portion Cp are disposed to pass through the internal electrodes 121 and 122 in the first direction, the present disclosure may have a more significant effect of suppressing occurrence and propagation of cracks.

In an example embodiment, the conductive glass Cg may be disposed to connect adjacent dielectric layers 111a and 111b to each other. Accordingly, bonding force between the dielectric layers 111a and 111b may be improved, thereby improving strength of the multilayer electronic component, suppressing delamination and cracks, and improving moisture resistance reliability.

The internal electrodes 121 and 122 may include first and second internal electrodes 121 and 122. The first and second internal electrodes 121 and 122 may be alternately disposed to oppose each other with the dielectric layer 111, included in the body 110, interposed therebetween, and may be exposed to the third and fourth surfaces 3 and 4 of the body 110, respectively.

The first internal electrode 121 may be spaced apart from the fourth surface 4 and exposed through the third surface 3, and the second internal electrode 122 may be spaced apart from the third surface 3 and exposed through the fourth surface 4. The first external electrode 131 may be disposed on the third surface 3 of the body and connected to the first internal electrode 121, and the second external electrode 132 may be disposed on the fourth surface 4 of the body and connected to the second internal electrode 122.

That is, the first internal electrode 121 may not be connected to the second external electrode 132 and may be connected to the first external electrode 131, and the second internal electrode 122 may not be connected to the first external electrode 131 and may be connected to the second external electrode 132. Accordingly, the first internal electrode 121 may be formed to be spaced apart from the fourth surface 4 by a predetermined distance, and the second internal electrode 122 may be formed to be spaced apart from the third surface 3 by a predetermined distance. In addition, the first and second internal electrodes 121 and 122 may be disposed to be spaced apart from the fifth and sixth surfaces of the body 110.

A conductive metal, included in the internal electrodes 121 and 122, may include at least one selected from the group consisting of Ni, Cu, Pd, Ag, Au, Pt, In, Sn, Al, Ti, and alloys thereof, but the present disclosure is not limited thereto.

A method of forming the internal electrodes 121 and 122 is not limited. For example, the internal electrodes 121 and 122 may be formed by coating an internal electrode conductive paste including a conductive metal and conductive glass onto a ceramic green sheet and sintering the same. The conductive metal may form an electrode portion Ep after sintering. The internal electrode conductive paste may be coated using a screen-printing method or gravure-printing method, but the present disclosure is not limited thereto.

An average thickness (te) of the internal electrode is not limited. In this case, a thickness of each of the internal electrodes 121 and 122 may refer to a size in the first direction of each of the internal electrodes 121 and 122. For example, the average thickness (te) of each of the internal electrodes 121 and 122 may be 5.0 μm or less.

Here, the average thickness (te) of the internal electrode may be measured by scanning, with an SEM, a cross-section of the body 110 in the first and second directions at a magnification of 10,000. More specifically, thicknesses of each of the internal electrodes 121 and 122 at multiple points, for example, thirty points spaced apart from each other at equal intervals in the second direction, may be measured to measure an average value thereof. The thirty points, spaced apart from each other at equal intervals, may be designated in the capacitance formation portion Ac. In addition, when such average value measurement is performed on ten internal electrodes 111 or ten internal electrodes 112, the average thickness of each of the internal electrodes 121 and 122 may be further generalized.

The external electrodes 131 and 132 may be disposed on the body 110 and connected to the internal electrodes 121 and 122.

As illustrated in FIG. 2, the external electrodes 131 and 132 may be disposed on the third and fourth surfaces 3 and 4 of the body 110, respectively, and may include first and second external electrodes 131 and 132 respectively connected to the first and second internal electrodes 121 and 122.

In the present example embodiment, a structure in which the multilayer electronic component 100 has two external electrodes 131 and 132 is described, but the number and shape of the external electrodes 131 and 132 may be changed depending on the form of the internal electrodes 121 and 122 or other purposes.

Each of the external electrodes 131 and 132 may be formed of any material having electrical conductivity, such as a metal or the like, and a specific material may be determined in consideration of electrical characteristics, structural stability, or the like. In addition, each of the external electrodes 131 and 132 may have a multilayer structure.

For example, the external electrodes 131 and 132 may include electrode layers 131a and 132a disposed on the body 110, and plating layers 131b and 132b formed on the electrode layers 131a and 132a.

As a more specific example of the electrode layers 131a and 132a, the electrode layers 131a and 132a may be a sintered electrode including a conductive metal and glass, or a resin-based electrode including a conductive metal and resin.

In addition, the electrode layers 131a and 132a may have a form in which a sintered electrode and a resin-based electrode are sequentially formed on a body. In addition, the electrode layers 131a and 132a may be formed by transferring a sheet including a conductive metal onto the body or by transferring a sheet including a conductive metal onto the sintered electrode.

A material having excellent electrical conductivity may be used as the conductive metal included in the electrode layers 131a and 132a, but the material is not limited. For example, the conductive metal may be at least one selected from the group consisting of nickel (Ni), copper (Cu), and an alloy thereof.

The plating layers 131b and 132b may serve to improve mounting characteristics. A type of each of the plating layers 131b and 132b is not limited, and each of the plating layers 131b and 132b may be a plating layer including at least one selected from the group consisting of Ni, Sn, Pd, and alloys thereof, and may be formed of a plurality of layers.

As a more specific example of the plating layers 131b and 132b, each of the plating layers 131b and 132b may be a Ni plating layer or a Sn plating layer, may have a form in which a Ni plating layer and a Sn plating layer are sequentially formed on the electrode layers 131a and 132a, and may have a form in which a Sn plating layer, a Ni plating layer, and a Sn plating layer are sequentially formed. In addition, each of the plating layers 131b and 132b may include a plurality of Ni plating layers and/or a plurality of Sn plating layers.

While example embodiments have been shown and described above, it will be apparent to those skilled in the art that modifications and variations could be made without departing from the scope of the present disclosure as defined by the appended claims.

In addition, the term “an example embodiment” used herein does not refer to the same example embodiment, and is provided to emphasize a particular feature or that characteristic different from of another example embodiment. However, example embodiments provided herein are considered to be able to be implemented by being combined in whole or in part one with one another. For example, one element described in a particular example embodiment, even if it is not described in another example embodiment, may be understood as a description related to another example embodiment, unless an opposite or contradictory description is provided therein.

The terms used herein are for the purpose of describing particular example embodiments only and are to not be limiting of the example embodiments. As used herein, the singular forms “a,” “an,” and “the” are intended to include the plural forms as well, unless the context clearly indicates otherwise.

What is claimed is:

1. A multilayer electronic component comprising:
a body including a dielectric layer and an internal electrode alternately disposed with the dielectric layer; and
an external electrode disposed on the body;
wherein the internal electrode includes a plurality of electrode portions and a plurality of disconnected portions, and
conductive glass is disposed in at least one of the plurality of disconnected portions.

2. The multilayer electronic component of claim 1,
wherein the internal electrode satisfies that a ratio of a length of the conductive glass to a length of the internal electrode is 0.1% to 15%.
the dielectric layer and the internal electrode are alternately disposed in a first direction, and
a ratio of a length of the conductive glass to a length of the internal electrode in the first direction is 0.1% to 15%.

3. The multilayer electronic component of claim 1, wherein the conductive glass includes Si and C.

4. The multilayer electronic component of claim 1, wherein
the conductive glass includes a core and a shell covering at least a portion of the core,
the core includes Si, and
the shell includes C.

5. The multilayer electronic component of claim 1, wherein the disconnected portion includes at least one of a pore, a dielectric, or the conductive glass.

6. The multilayer electronic component of claim 1, wherein
the dielectric layer and the internal electrode are alternately disposed in a first direction, and
the disconnected portion is disposed to pass through the internal electrode in the first direction.

7. The multilayer electronic component of claim 1, wherein
the dielectric layer and the internal electrode are alternately disposed in a first direction, and
the disconnected portion is disposed to pass through the internal electrode in the first direction.

8. The multilayer electronic component of claim 1, wherein the conductive glass is disposed to connect adjacent dielectric layers to each other.

9. The multilayer electronic component of claim 1, wherein at least one of the plurality of disconnected portions includes the conductive glass.

10. The multilayer electronic component of claim 1, wherein
the internal electrode satisfies that a ratio of a length of the electrode portion to a length of the internal electrode is 75% to 95%.

11. The multilayer electronic component of claim 1,
wherein
the internal electrode satisfies that a length ratio occupied by the conductive glass in the disconnected portion is 50% or more.

12. The multilayer electronic component of claim 1, wherein the electrode portion includes Ni as a main element.

13. The multilayer electronic component of claim 5, wherein the dielectric includes a material the same as a material included in the dielectric layer.

14. The multilayer electronic component of claim 5, wherein the dielectric includes BaTiO₃ as a main element.
